(19) United States
(12) Patent Application Publication
(10) Pub. No.: US 2025/0286221 A1
(43) Pub. Date: Sep. 11, 2025

(54) MULTI-ANODE ELECTROCHEMICAL CELL WITH IMPROVED DISCHARGE PERFORMANCE

(71) Applicant: Energizer Brands, LLC, St. Louis, MO (US)

(72) Inventors: Guanghong Zheng, Westlake, OH (US); Xiaotong Chadderdon, Westlake, OH (US)

(21) Appl. No.: 18/884,744

(22) Filed: Sep. 13, 2024

Related U.S. Application Data
(60) Provisional application No. 63/561,955, filed on Mar. 6, 2024.

(51) Int. Cl. H01M 50/46; H01M 4/02; H01M 4/24; H01M 50/489

(52) U.S. Cl. CPC H01M 50/46; H01M 50/489; H01M 2004/027; H01M 4/244

(57) ABSTRACT

Electrochemical cells are provided. An electrochemical cell may include a cell housing. The cell housing may include a cylindrical container having an interior radius and a closure. The electrochemical cell may further include a cathode positioned within the cylindrical container and defining a plurality of cylindrical openings therein, a cylindrical anode disposed within each opening of the plurality of cylindrical openings to form a plurality of anodes, a current collector extending into each anode of the plurality of anodes and electrically connecting each anode of the plurality of anodes with a negative terminal of the cell housing, and a separator disposed within each opening of the plurality of cylindrical openings and between each anode and the cathode. A relative anode distance parameter kᵣ for the electrochemical cell may be between 0.4 and 0.8.

### CROSS REFERENCE TO RELATED APPLICATIONS

This application claims priority to U.S. Provisional Patent Application No. 63/561,955 filed on Mar. 6, 2024, which is incorporated herein by reference in its entirety.

The present disclosure relates generally to electrochemical cells, and more particularly to multi-anode electrochemical cells with improved discharge performance.

### BACKGROUND

Batteries in the form of electrochemical cells are used as power sources for a wide range of electronic devices. The requirements of those electronic devices are important factors in battery design. For example, many electronic devices have battery compartments that limit the size and/or shape of batteries to be contained therein. Thus, certain electrochemical cells, such as alkaline primary batteries, are commercially available in cell sizes commonly known as LR6 (AA), LR03 (AAA), LR14 (C) and LR20 (D). The cells have a cylindrical shape that must comply with the dimensional standards that are set by organizations such as the International Electrotechnical Commission. Moreover, the discharge characteristics of the batteries should be provided to accommodate the intended device operation under expected conditions of use.

Over time, many electronic devices have incorporated increasing numbers of features that require higher-power draws from onboard batteries to appropriately power the devices. The increased high-power demands of these electronic devices require batteries capable of delivering consistent high-rate discharge performance over an extended period of time. However, high-rate discharge of many conventional batteries, such as conventional batteries incorporating a single anode and a single cathode configuration, often results in decreases in discharge efficiency, with a battery often failing to deliver desired voltage outputs well before all of the active material within the battery is exhausted. Alkaline cell performance in the form of discharge efficiency differs depending on whether the cell is being used in a low-rate (e.g., low current draw) application or a high-rate (e.g., high current draw) application. For high-rate applications, conventional alkaline cells have been observed to have low discharge efficiency limited by low interfacial area of the alkaline cells which is confined by the anode-to-cathode ratio and the internal volume of the can.

The inventors have found that the interfacial area of an alkaline cell can be increased by having multiple anode compartments within an alkaline cell, which increases the discharge efficiency at high-rate applications. However, discharge efficiency of cells having multiple anode compartments may be impacted by various design factors.

Accordingly, a need exists for improvements in battery design to improve discharge efficiency under various discharge rate circumstances.

### BRIEF SUMMARY

In general, embodiments of the present disclosure provide electrochemical cells, and/or the like.

According to various embodiments, there is provided an electrochemical cell including a cell housing comprising cylindrical container having an interior radius xₜₒₜ and a closure; a cathode positioned within the cylindrical container and defining a plurality of cylindrical openings therein; a cylindrical anode disposed within each opening of the plurality of cylindrical openings to form a plurality of anodes, wherein each cylindrical anode has a radius r₂; a current collector extending into each anode of the plurality of anodes and electrically connecting each anode of the plurality of anodes with a negative terminal of the cell housing; and a separator disposed within each opening of the plurality of cylindrical openings and between each anode and the cathode wherein the separator has a thickness xₛ; wherein:

$${r}_{1 , max} = {x}_{tot} - {r}_{2} - {x}_{s}$$

$${r}_{1 , min} = \frac{( {r}_{2} + {x}_{s} )}{cos ( 30 ° )}$$

$${r}_{1} = {r}_{1 , min} + ( {r}_{1 , max} - {r}_{1 , min} ) {k}_{r}$$

r₁ is a distance between a center of the cylindrical container and a center of each cylindrical anode, and
kᵣ is a coefficient between 0.4-0.8.

In some embodiments, the plurality of anodes consists of three anodes.

In some embodiments, the thickness of the separator is between 0.1 mil and 1 mil.

In some embodiments, the thickness of the separator is between 1 mil and 5 mil.

In some embodiments, the thickness of the separator is between 5 mil and 10 mil.

In some embodiments, the thickness of the separator is between 10 mil and 18 mil.

In some embodiments, the thickness of the separator is between 10 mil and 18 mil, and a ratio between a quantity of anode active material within the plurality of anodes to a quantity of cathode active material within the cathode is between 1.1 and 1.3.

In some embodiments, the anode material comprises Zinc and the cathode active material comprises manganese dioxide.

In some embodiments, the thickness of the separator is between 0.1 mil and 1 mil, kᵣ is between 0.5 and 0.7, and a ratio between a quantity of anode active material within the plurality of anodes to a quantity of cathode active material within the cathode is between 1.1. and 1.3.

In some embodiments, the thickness of the separator is between 1 mil and 18 mil, kᵣ is between 0.5 and 0.7, and a ratio between a quantity of anode active material within the plurality of anode to a quantity of cathode active material within the cathode is between 1.1 and 1.3.

In some embodiments, centers of the plurality of anodes are spaced equally around a circle having a radius r₁ within the cylindrical container.

In some embodiments, the current collector comprises a plurality of conductive prongs electrically connected to an outer cover.

In some embodiments, the kᵣ is about 0.6.

In some embodiments, the kᵣ is between 0.5 and 0.7.

According to various embodiments, there is provided a method of manufacturing an electrochemical cell, including placing a cathode within a cell housing comprising a cylindrical container having an interior radius xₜₒₜ and a closure, wherein the cathode is in contact with an interior surface of the cylindrical container and defines a plurality of cylindrical openings, each cylindrical opening having an inner surface; covering the inner surface of each cylindrical opening of the plurality of cylindrical openings with a separator; wherein the separator has a thickness xₛ; disposing cylindrical anode within each cylindrical opening to form a plurality of anodes, wherein each cylindrical anode has a radius r₂, wherein each cylindrical anode of the plurality of anodes is separated from the cathode by the separator; extending a current collector into each anode of the plurality of anodes, wherein the current collector is electrically connected to a negative terminal cover; and sealing the cylindrical container with the negative terminal cover; wherein:

$${r}_{1 , max} = {x}_{tot} - {r}_{2} - {x}_{s}$$

$${r}_{1 , min} = \frac{( {r}_{2} + {x}_{s} )}{cos ( 30 ° )}$$

$${r}_{1} = {r}_{1 , min} + ( {r}_{1 , max} - {r}_{1 , min} ) {k}_{r}$$

r₁ is a distance between a center of the cylindrical container and a center of each cylindrical anode; and
kᵣ is a coefficient between 0.4 and 0.8.

In some embodiments, the plurality of anodes consist of three anodes.

In some embodiments, the kᵣ is about 0.6.

In some embodiments, the kᵣ is between 0.5 and 0.7.

In some embodiments, the current collector comprises a plurality of conductive prongs electrically connected to an outer cover.

According to various embodiments, there is provided a tool set for forming a cathode pellet including a plurality of core rods configured for being positioned vertically on the cylindrical base plate; a cylindrical die defining an opening therethrough, wherein the cylindrical die is configured for being positioned over the plurality of core rods, wherein the cylindrical die has a diameter that is substantially the same as a diameter of the cylindrical base plate; and a ram configured for being positioned over the cylindrical die, wherein the ram comprises a ram plate and a ram rod extending from the ram plate, the ram plate has a diameter that is greater than a diameter of ram rod, the ram rod defines a plurality of through holes having a diameter that is substantially the same as a diameter of each core rod of the plurality of core rods, and the plurality of core rods are configured for being inserted within the plurality of through holes when pressure is applied to the ram.

The above summary is provided merely for purpose of summarizing some example aspects to provide a basic understanding of some aspects of the disclosure. Accordingly, it will be appreciated that the above-described aspects are merely examples. It will be appreciated that the scope of the disclosure encompasses many potential aspects in addition to those here summarized, some of which will be further described below.

### BRIEF SUMMARY OF THE DRAWINGS

Having thus described the disclosure in general terms, reference will now be made to the accompanying drawings, which are not necessarily drawn to scale, and wherein:

FIG. 1 is a side, cross-sectional view of an example electrochemical cell in accordance with at least some embodiments.

FIGS. 2a-2f illustrates cross-sectional view of an example electrochemical cell showing different coefficient kᵣ configurations in accordance with at least some embodiments.

FIG. 3 is a cover and seal assembly with current collector for insertion into a cell container in accordance with at least some embodiments.

FIGS. 4a-4c illustrate forming tools for forming a cathode in accordance with at least some embodiments.

FIG. 4d illustrates an example cathode pellet formation for an example electrochemical cell in accordance with at least some embodiments.

FIG. 5 graphically illustrates a discharge profile for an example electrochemical cell in accordance with at least some embodiments.

FIG. 6 graphically illustrates relation between run time and separator thickness in accordance with at least some embodiments.

FIG. 7 graphically illustrate relation between run time and anode-to-cathode ratio in accordance with some embodiments.

FIG. 8 graphically illustrates relation between run time and coefficient in accordance with some embodiments.

FIG. 9 illustrates electrochemical cell performance measured against various design parameters in accordance with some embodiments.

### DETAILED DESCRIPTION AND DISCUSSION

Various embodiments now will be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item. For example, “an additive” may refer to one, two, or more additives.

To the extent they are not explicitly mutually inconsistent, each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths, hundredths, thousandths, ten-thousandths, and hundred-thousandths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 7-10%, 5.1%-9.9%, and 5.01%-9.99%. As another example, “0.00001-1 M” includes 0.00005-0.0001 M and 0.001-0.01 M.

As used herein, “about” in the context of a numerical value or range means within +10% of the numerical value or range recited or claimed.

As used herein, “run-time” refers to the length of time that an electrochemical cell will be able to provide a certain level of charge.

Unless otherwise specified, as used herein the terms listed below are defined and used throughout this disclosure as follows:

Ambient temperature or room temperature-between about 20° C. and about 25° C. Unless otherwise stated, all examples, data and other performance and manufacturing information were conducted at ambient temperature and under normal atmospheric conditions.

Anode—the negative electrode, to serve as the primary electrochemically active material, with an example active material being Zinc.

Capacity—the capacity delivered by a cell during discharge at a specified set of conditions (e.g., drain rate, temperature, etc.); typically expressed in milliamp-hours (mAh) or milliwatt-hours (mWh) or by the number of minutes or images taken on the digital still camera (DSC) test. As discussed herein, capacity may be expressed and/or measured for low-rate discharge and/or high-rate discharge (e.g., using the DSC test for high-rate discharge).

Cathode—the positive electrode; in some embodiments, the active material of cathode may be manganese dioxide (MnO₂), such as electrolytic manganese dioxide (EMD).

Cell housing—the structure that physically encloses the electrode assembly (e.g., the anode, cathode, separator, and current collector). The cell housing comprises all internally enclosed safety devices, inert components and connecting materials which comprise a fully functioning battery; typically these will include a container (formed in the shape of a cup, also referred to as a “can” or a “receptacle”) and a closure (fitting over the opening of the container and normally including venting and sealing mechanisms for impeding electrolyte egress and moisture/atmospheric ingress); depending upon the context may sometimes be used interchangeably with the terms can or container.

Cylindrical cell size—any cell housing having a circular-shaped cylinder.

Electrochemically active material—one or more chemical compounds that are part of the discharge reaction of a cell and contribute to the cell discharge capacity but including impurities and small amounts of other moieties inherent to the material. For an example alkaline primary cell, the electrochemically active materials comprise EMD and zinc.

LR6 or AA-sized cell—With reference to International Standard IEC-60086-1 published by the International Electrotechnical Commission after November 2000, a cylindrical cell size zinc-manganese dioxide (Zn—MnO₂) battery with a maximum external height of about 50.5 mm and a maximum external diameter of about 14.5 mm.

LR03 or AAA-sized cell—With reference to International Standard IEC-60086-1 published by the International Electrotechnical Commission after November 2000, a cylindrical cell size zinc-manganese dioxide (Zn—MnO₂) battery with a maximum external height of about 44.5 mm and a maximum external diameter of about 10.5 mm.

Interfacial area—surface area between the anode and the cathode. For cells with multiple anodes as described herein, the interfacial area is the total interfacial area, considering the interfacial area between the cathode and each of the plurality of anodes.

Center-to-center distance—distance between the center axis of an anode to the center axis of the cell, referred to herein as r₁. In embodiments, where the centers of the anodes are spaced equally around a circle having a radius r₁, and all of the anodes have substantially the same radius r₂, the center-to-center distance is at least substantially the same with respect to each anode.

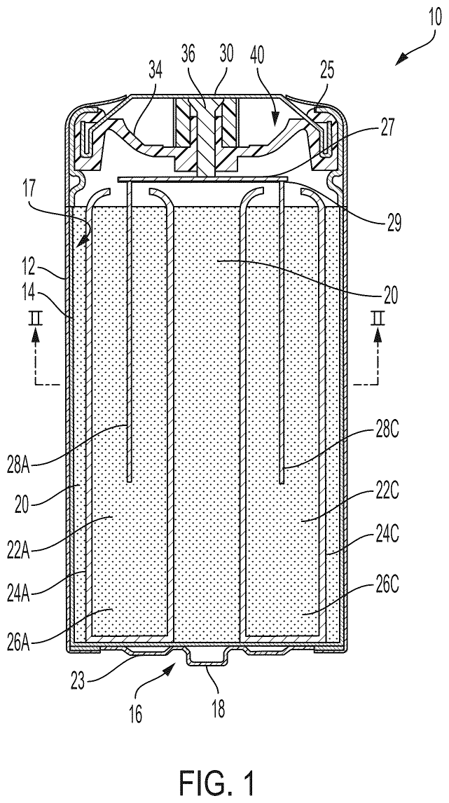

Referring to FIG. 1, a cell 10 is shown as one embodiment of a cylindrical electrochemical cell, although this disclosure applies similarly to other electrochemical cells having various sizes and configurations. The cell 10 has, in one embodiment, a housing that includes a container in the form of a can 12 with a closed bottom end 23 and an open top end 25. The container may be a cylindrical container. The can 12 has an inner wall 17 and defines an interior radius xₜₒₜ. A positive terminal cover 16 is welded or otherwise attached to the bottom end of can 12. Alternatively, the bottom end 23 of can 12 may be formed to include the shape of positive terminal cover 16. In one embodiment, the positive terminal cover 16 can be formed of plated steel, for example, with a protruding nub 18 at its center region. Assembled to the open top end 25 of the can 12 is cover and seal assembly 40 and outer cover 30 which forms the negative contact terminal of cell 10.

The can material and thickness of the can wall will depend in part on the active materials and electrolyte used in the cell. In one embodiment, the can 12 can be formed of a metal, such as steel, which may be plated on its interior with nickel, cobalt, and/or other metals or alloys, or other materials, possessing sufficient structural properties that are compatible with the various inputs in an electrochemical cell. The type of plating can be varied to provide varying degrees of corrosion resistance, to improve the contact resistance or to provide the desired appearance. The type of steel will depend in part on the manner in which the container is formed. For a drawn can, the steel can be a diffusion annealed, low carbon, aluminum killed, SAE 1006 or equivalent steel. With a grain size of ASTM 9 to 11 and equiaxed to slightly elongated grain shape. Other steels such as stainless steels, can be used to meet special needs. For example, when the can 12 is in electrical contact with the cathode, a stainless steel may be used for improved resistance to corrosion by the cathode and electrolyte.

A label 14 can be formed about the exterior surface of can 12 and can be formed over peripheral edges of the positive terminal cover 16 and negative terminal cover 30, as long as the negative terminal cover 30 is electrically insulated from container 12 and positive terminal cover 16.

The positive terminal cover 16 and negative terminal cover 30 should have good resistance to corrosion by water in the ambient environment or other corrosives commonly encountered in battery manufacture and use, good electrical conductivity and, when visible on consumer batteries, an attractive appearance. Terminal covers are often made from nickel plated cold rolled steel or steel that is nickel plated after the covers are formed. Where terminals are located over pressure relief vents, the terminal covers generally have one or more holes to facilitate cell venting.

A first electrode 26 (e.g., 26A-26C) and a second electrode 20 with separator 24 are disposed within the interior of the can 12 and cover and seal assembly 40 secured to open top end 25 of can 12. Closed bottom end 23, sidewall of can 12, and the cover and seal assembly 40 define a cavity in which the electrodes and separator of the cell are housed.

First electrode 26 may be a negative electrode or anode. The negative electrode may include a mixture of one or more active materials (e.g., zinc), and electrically conductive material, solid zinc oxide, and/or, in some embodiments, a surfactant. The negative electrode can optionally include other additives, for example a binder or a gelling agent, and the like. Zinc is an example main active material for the negative electrode of the embodiments. Preferably, the volume of active material utilized in the negative electrode is sufficient to maintain a desired particle-to-particle contact and a desired anode-to-cathode (A:C) ratio. In some embodiments, the anode may comprise micron-scale Zinc particles suspended in a gelled electrolyte of concentrated potassium hydroxide (KOH) in water.

Particle-to-particle contact should be maintained during the useful life of the battery. If the volume of active material in the negative electrode is too low, the cell's voltage may suddenly drop to an unacceptably low value when the cell is powering a device. The voltage drop is believed to be caused by a loss of continuity in the conductive matrix of the negative electrode. The conductive matrix can be formed from undischarged active material particles, conductive electrochemically formed oxides, or a combination thereof. A voltage drop can occur after oxide has started to form, but before a sufficient network is built to bridge between all active material particles present.

Zinc suitable for use in the embodiments may be purchased from a number of different commercial sources under various designations, such as BIA 100 and BIA 115. Umicore S. A., Brussels, Belgium is an example of a zinc supplier. In a preferred embodiment, the zinc powder generally has 25 to 40 percent fines less than 75 μm, and preferably 28 to 38 percent fines less than 75 μm. Generally lower percentages of fines will not allow desired DSC service to be realized and utilizing a higher percentage of fines can lead to increased gassing. A correct zinc alloy is needed in order to reduce negative electrode gassing in cells and to maintain test service results.

A surfactant that is either a nonionic or anionic surfactant, or a combination thereof is usually present in the anode. It has been found that anode resistance is increased during discharge by the addition of solid zinc oxide alone but is mitigated by the addition of the surfactant. The addition of the surfactant increases the surface charge density of the solid zinc oxide and lowers anode resistance as indicated above.

Second electrode 20 may be a positive electrode or cathode 20. The positive electrode may include EMD as the electrochemically active material. EMD is present in an amount generally from about 80 to about 92 weight percent and preferably from about 81 to 85 weight percent based on the total weight of the positive electrode, i.e., manganese dioxide, conductive material, positive electrode electrolyte and additives, including organic additive(s), if present. The cathode can also contain small amounts of one or more additional active materials, depending on the desired cell electrical and discharge characteristics. The additional active cathode material may be any suitable active cathode material. Examples include metal oxides, Bi₂O₃, C₂F, CFₓ, (CF)ₙ, CoS₂, CuO, CuS, FeS, FeCuS₂, MnO₂, Pb₂Bi₂O₅, nickel oxide, nickel hydroxide and S.

The cathode can include other components such as a conductive material, for example graphite, that when mixed with the EMD provides an electrically conductive matrix substantially throughout the positive electrode. Conductive material can be natural, i.e., mined, or synthetic, i.e., manufactured. In one embodiment, the cell 10 includes a positive electrode having an active material or oxide to carbon ratio (O:C ratio) that ranges from about 12 to about 24. In an embodiment, the O:C ratio ranges from about 12-14. Too high of an oxide to carbon ratio increases the container to cathode resistance, which affects the overall cell resistance and can have a detrimental effect on high-rate discharge performance, which may be evident from the DSC test, and/or may have a detrimental impact on cell uses that are reliant on higher cut-off voltages (e.g., cut-off voltages above 1.05V). Furthermore, the graphite can be expanded or non-expanded. Suppliers of graphite for use in alkaline batteries include Superior Graphite Company of Chicago, Ill.; and Lonza, Ltd. of Basel, Switzerland. Conductive material is present generally in an amount from about 5 to about 10 weight percent based on the total weight of the positive electrode. Too much graphite can reduce EMD input, and thus cell capacity; too little graphite can increase current collector to cathode contact resistance and/or bulk cathode resistance. Other additives, such as barium sulfate (BaSO₄), barium acetate, titanium dioxide, binders such as coathylene, and calcium stearate, nickelate materials, and/or other additives may be utilized based on specific electrochemical cell chemistries utilized. Moreover, certain additives may be provided to facilitate manufacturing of a cathode suitable for inclusion in a multi-anode electrochemical cell.

In one embodiment, a positive electrode component (EMD), conductive material, and optionally additive(s) are mixed together to form a homogeneous mixture. During the mixing process, an alkaline electrolyte solution, such as a KOH solution, optionally including organic additive(s), is evenly dispersed into the mixture thereby insuring a uniform distribution of the solution throughout the positive electrode materials.

The cathode 20 is formed about the interior side surface/inner wall 17 of can 12. The cathode 20 has a plurality of anode cavities (also referred to herein as anode compartments or openings, such as cylindrical openings) formed therein and preferably extending through the entire length of the cathode 20. In the illustrated embodiment, the cathode 20 has three anode cavities 22A-22C, formed therein. In other embodiments, the cathode 20 may include more than three anode cavities or may include only two anode cavities. However, the inventors have found that a cell having three anode cavities (and having 3 anodes, each separated from the cathode by a separator) may have certain advantages over cells having less than three anode cavities or more than three anode cavities. For example, the inventors have found that a cell having three anode compartments advantageously has higher interfacial area compared to a cell having less than three anode compartments.

Three separators 24A-24C are disposed within the corresponding anode cavities 22A-22C such that the outer face of each separator is disposed against the interior surface of the cathode 20. Each separator may have an inward-folded extension that covers the interior bottom of the can 12 to prevent the anodes 26A-26C from contacting the can 12. For example, each separator may have a cylindrical cup shape. The separators 24A-24C maintain a physical dielectric separation of the positive electrode's electrochemically active material from the electrochemically active material of the negative electrode and allows for transport of ions between the electrode materials. In addition, in some embodiments, the separators 24A-24C may act as a wicking medium for the electrolyte. Separators 24A-24C can be a layered ion permeable, non-woven fibrous fabric and can be cup-shaped. A typical separator usually includes two or more layers of paper.

Each of the separators 24A-24C preferably extends through the corresponding anode cavities 22A-22C, respectively, and may have an excess amount of separator material extending above the top surface of cathode 20. Anodes 26A-26C are injected or otherwise disposed within each of the separators 24A-24C, respectively. Accordingly, the corresponding anodes 26A-26C are disposed against an inner face of the corresponding separators 24A-24C. In some embodiments, each of the anodes 26A-26C may include a gel type anode formed of non-amalgamated zinc powder, a gelling agent, and other additives, and mixed with an electrolyte solution which may be formed of potassium hydroxide, zinc oxide and water. It should be appreciated that various types of anodes and cathodes may be used without departing from the teachings of the present disclosure.

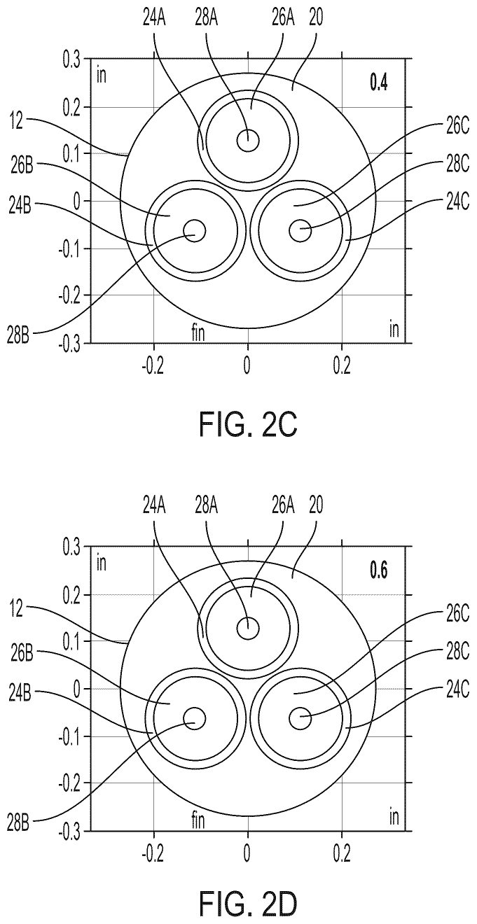

A multi-prong current collector is disposed within the cell 10. FIG. 3 illustrates an example multi-prong current collector 28 attached (physically and electrically) with cover and seal assembly 40. In various embodiments, the number of prongs of the multi-prong current collector is the same as the number of anode compartments. For example, a three-prong current collector 28 (such as the current collector 28 shown in FIG. 3) having three conductive prongs 28A-28C extends within the anodes 26A-26C. Each of the conductive prongs 28A-28C extends within one of the anodes 26A-26C so as to realize contact with the anode material, such as for example, zinc paste. Each conductive prong of the plurality of conductive prongs 28A-28C has an identical length, and the length of the conductive prongs is configured such that the conductive prongs 28A-28C extend through substantially the entire length of the anodes (e.g., through greater than 50% of the anode length, or more preferably through greater than 80% of the anode length) The three conductive prongs 28A-28C are physically and electrically connected to a metal terminal of the cover and seal assembly 40 such that anodes 26A-26C are electrically connected to each other and to the negative terminal. Accordingly, the three-prong current collector 28 provides a conductive path from the anodes 26A-26C to the negative terminal.

In some embodiments, the three-prong current collector 28 is conductive and may comprise one or more elongated nail or bobbin-shaped component. The three-prong current collector 28 may be made of metal or metal alloys, such as copper or brass, conductively plated metallic or plastic collectors, or the like. Other suitable materials can be utilized.

Assembled to the open top end 25 of the can 12 is the cover and seal assembly 40, which provides a closure to the assembly of cell 10. The cover and seal assembly 40 includes an inner seal body 34, that may include nylon, and in some embodiments, may include an inner cover that is disposed on top of the seal body 34. The inner cover may be disposed in the open top end 25 of the cell such that, when the top edge of the can 12 is crimped inward and/or reduced in diameter, the inner cover cooperates with the seal body 34 and the can 12 to compressively seal the electrodes and/or electrolyte in the cell 10.

The multi-prong current collector (e.g., three-prong current collector 28 in the illustrated embodiment) may be preassembled as part of the cover and seal assembly 40. In some embodiments, the multi-prong current collector may be preassembled as part of the cover and seal assembly 40 such that the current collector prongs extend through openings in the inner cover and/or seal body 34 and prevents leakage of active ingredients contained in can 12. Seal body 34 contact and seal each of conductive prongs 28A-28C of current collector 28 and further provides a seal within the interior surface of the top end of can 12. An outer negative terminal cover 30, which may be formed of a plated steel may be disposed at the open top end 25. In some embodiments, the outer negative terminal cover 30 may be disposed in contact with a nail 36 (e.g., AA nail, etc.) within the open top end 25 and may be spot-welded via a weld or otherwise connected to the open top end 25 of the current collector 28. In some embodiments, the outer negative terminal cover 30 may be disposed in contact with an inner cover and may be spot-welded via a weld or otherwise connected to the top end of current collector 28. The negative terminal cover 30 is electrically insulated from can 12 via seal body 34. The seal body 34, for example, may comprise a gasket.

The inner cover can be metal. Nickel plated steel or stainless steel may be used as the closure and cover are in electrical contact with the cathode in certain embodiments. The complexity of the inner cover shape may be a factor in material selection. The inner cover may have a simple shape, such as a thick, flat disk, or it may have a more complex shape. When the cover has a complex shape, a type 304 soft annealed stainless steel with ASTM 8-9 grain size may be used to provide the desired corrosion resistance and ease of metal forming. Formed covers may also be plated, with nickel for example, or made from stainless steel or other known metals and their alloys.

The seal body 34 may be made from any suitable thermoplastic material that provides the desired sealing properties. Material selection may be based in part on the electrolyte composition. Examples of suitable materials include polypropylene, polyphenylene sulfide, tetrafluoride-perfluoroalkyl vinyl ether copolymer, polybutylene terephthalate and combinations thereof. Preferred seal body 34 materials include polypropylene (e.g., PRO-FAX® 6524 from Basell Polyolefins in Wilmington, Del., USA) and polyphenylene sulfide (e.g., XTEL™ XE3035 or XE5030 from Chevron Phillips in The Woodlands, Tex., USA). Small amounts of other polymers, reinforcing inorganic fillers and/or organic compounds may also be added to the base resin of the seal body 34. In one embodiment, the seal body 34 can be formed from a polymeric or elastomer material, for example Nylon-6,6, an injection-moldable polymeric blend, such as polypropylene matrix combined with poly(phenylene oxide) or polystyrene, or another material, such as a metal, provided that the current collector 28 and negative terminal 30 are electrically insulated from can 12 which serves as the current collector for the second electrode 20 (e.g., cathode 20). Current collector 28 may serve as the current collector for the first electrode (e.g., anodes 26A-26C). The seal body 34 may be coated with a sealant to provide the best seal. Ethylene propylene diene terpolymer (EPDM) is a suitable sealant material, but other suitable materials can be used. In some embodiments, the seal body 34 may include a pressure relief configured to rupture if the cell's internal pressure becomes excessive.

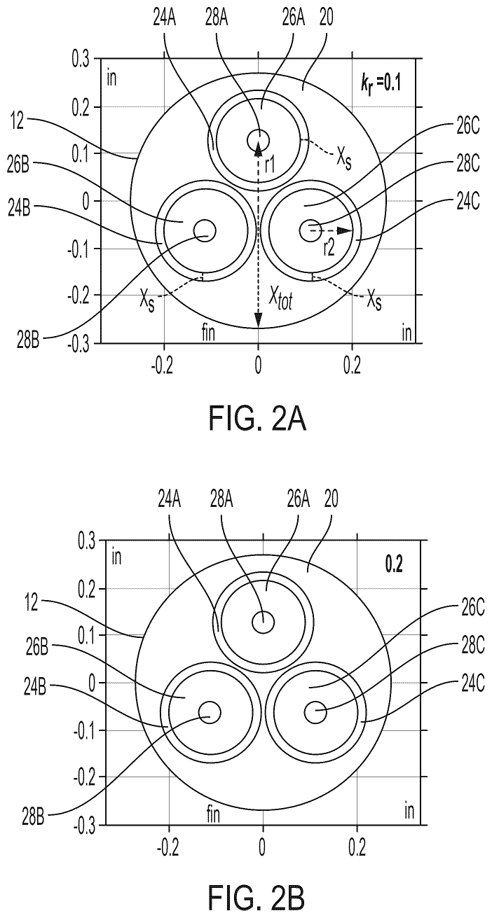

Referring to FIGS. 2a-2f, a cross-sectional view of cell 10 taken through lines II-II is shown for different relative anode location configurations. Specifically, FIGS. 2a-2f show different relative anode locations based on coefficient kᵣ (also referred to herein as relative anode distance parameter kᵣ) for a cell having three anode compartments that have an identical radius r₂ and are spaced equally (e.g., at approximately 120° relative to one another) around a circle having radius r₁ centered with the center of the container. It will be appreciated that in some embodiments, the anode compartments may be unsymmetrically arranged without departing from the teaching of the present disclosure.

The coefficient kᵣ for a cell 10 may be between from 0 to 1 and may be associated with the relative location of the anodes. For example, as shown in FIGS. 2a-2f, the anodes 26A-26C of cell 10 having a coefficient kᵣ of 0.1 are closer together compared to anodes 26A-26C of cell 10 having a coefficient kᵣ of 0.2. Similarly, the anodes 26A-26C of cell 10 having a coefficient kᵣ of 0.2 are closer together compared to anodes 26A-26C of cell 10 having a coefficient kᵣ of 0.4, and so on. The distance between the center of an anode to the center of the cell can 12 (referred to herein as center-to-center distance) may be adjustable but bounded by the diameter of the cell can 12 and the diameter of the anodes.

The inventors have found that the discharge performance of a cell may be optimized by selecting a kᵣ value that is most-appropriate for a cell design, based on the radius of the anodes 2 (which itself is dependent on the A:C ratio for the cell) and the thickness of the separator xₛ. The kᵣ value may be selected to optimize high-rate discharge performance of the cell (e.g., to maximize the DSC runtime of the cell). Selecting an appropriate kᵣ value to maximize the high-rate discharge run time of a cell is a single variable of a multi-variable process for maximizing the total high-rate discharge run time for the cell. Other factors, such as the A:C ratio and separator thickness may provide additional changes in the high-rate discharge performance of the cell. For example, DSC run time of a multi-anode cell may increase with increasing anode-to-cathode ratio due to, for example, limitation in anode polarization. Further, DSC run time of a multi-anode cell may decrease with increasing separator thickness due to, for example, less electrode input.

The anode-to-cathode ratio, separator thickness, and relative anode location design parameters may be interrelated such that the combination of the anode-to-cathode ratio, separator thickness, and relative anode location must be carefully selected to achieve optimal discharge performance. The anode-to-cathode ratio, separator thickness, and coefficient kᵣ may have a relation defined by the following equations 1-3.

$${r}_{1} = {r}_{1 , min} + ( {r}_{1 , max} - {r}_{1 , min} ) \cdot {k}_{r} \qquad Equation 1$$

$${r}_{1 , max} = {x}_{tot} - {r}_{2} - {x}_{s} \qquad Equation 2$$

$${r}_{1 , min} = \frac{( {r}_{2} + {x}_{s} )}{cos 30 °} \qquad Equation 3$$

In equations 1-3 above, kᵣ is the relative anode distance parameter, xₛ is the separator thickness (e.g., thickness of the separator), r₁ represents the distance between the center of an anode to the center of the cell (also referred to herein as center-to-center distance), r_{1,min} represents the minimum distance between the center of an anode to the center of the cell configured to prevent the anode cavities, with a defined radius and separator thickness, from overlapping with one another, r_{1,max} represents the maximum distance between the center of an anode to the center of the cell configured to prevent the anode cavities from overlapping with the container 12 based on the radius and separator thickness, xₜₒₜ represents the internal radius of the cell, r₂ represents the radius of the anode. The radius of an anode r₂ depends on the anode-to-cathode capacity ratio of the cell. For example, the ratio between a quantity of anode active material within the plurality of anodes to a quantity of cathode active material within the cathode may at least in part determine r₂.

Specifically, as indicated in equation 1, a relation between the center-to-center distance r₁ and the coefficient kᵣ is defined by r₁=r_{1,min}+ (r_{1,max}−r_{1,min})·kᵣ, the maximum center-to-center distance r_{1,max} is defined by r_{1,max}=xₜₒₜ−r₂−xₛ, and the minimum center-to-center distance r_{1,min} is defined by r_{1,min}=(r₂+xₛ)/cos 30°.

In various embodiments, the cell 10 may have A:C ratio between about 1.0 to about 2.0. In various embodiments, the A:C ratio is preferably between about 1.0 to about 1.5. In various embodiments, the A:C ratio is more preferably between about 1.1 to about 1.5. In various embodiments, the A:C ratio is most preferably between about 1.1 to 1.3. The inventors have found that different A:C ratios require different kᵣ values to optimize high-rate discharge performance.

In various embodiments the cell 10 may have a separator thickness between about 0.1 to 18 mil. This includes between about 0.1 mil to 1 mil, between about 1 mil to 5 mil, between about 5 mil to 10 mil, and a between about 10 mil to 18 mil, for example. The inventors have found that the usage of different separator thicknesses results in different values of kᵣ being optimal for cell design.

In various embodiments the cell 10 may have coefficient kᵣ between about 0 to 1. In various embodiments, the coefficient kᵣ is preferably between about 0.4 to 0.8, more preferably between about 0.5 to 0.7, and most preferably about 0.6. Further, the inventors have found that to mitigate risk of cracking the cathode during electrode processing, the coefficient kᵣ should be no greater than 0.9 and no less than 0.3 at least for cells having three anodes.

### Example Method of Manufacture

Referring to FIG. 3, a cover and seal assembly 40 with current collector for insertion into the cell container is shown. As described above, the cell 10 may include a cover and seal assembly 40 which closes the open end of the can 12. As further described above, a multi-prong current collector 28 may be preassembled as part of the cover and seal assembly 40, such that the cover and seal assembly 40 with the current collector may be inserted into the cell can 12 with each current collector prong extending through a respective anode compartment and disposed within the anode therein.

The cover and seal assembly with the current collector may be formed via one or more manufacturing methods. In some embodiments, a nail, preferably AA nail, is inserted into a seal 39. The nails for example may comprise an AA nail. In some embodiments, the seal 39 may be a nylon seal and/or may be annular. In some embodiments, an outer peripheral upstanding wall 40a is formed along the perimeter of the seal and an inner upstanding wall in the form of a central thickened hub is formed at the center of the seal. The seal's central hub may have a cylindrical opening defined vertically therethrough for receiving the nail. For example, an AA nail may be inserted into the central hub. In one embodiment, the nail may have a length of about 0.025 inches. In some embodiments, a nail having a length longer than 0.025 inches is first inserted in the central hub, and then the nail is cut down or otherwise reduced to about 0.025 inches. It would be appreciated that in some embodiments, the nail may have a length that is less than 0.025 inches or greater than 0.025 inches. A negative cover is then welded or otherwise attached to the nail. For example, the negative cover may be welded to the nail using a welder.

In some embodiments, to attach current collector 28 to the cover and seal assembly 40, a hole is formed or otherwise defined in the center of a disc 27 (e.g., a first disc 27 shown in FIG. 1). In some embodiments, the disc may be formed from brass. For example, the disc may be punched from a thin brass shim. In some embodiments, the disc may be formed from other conductive materials. A set of elongated nails, such as AA nails may be welded or otherwise attached to the disc. The elongated nails form the prongs of the current collector 28. The elongated nails may be made of metal or metal alloys, such as copper or brass, or other suitable materials. The set of nails may be symmetrically arranged radially along the disc such that each nail extends from the disc. For example, for a cell having three symmetrically arranged anodes within the can 10, each nail may be positioned at 120° apart radially along the disc to form a three-prong current collector for inserting within the anodes. The center hole of the disc is pressed into the nail on the seal such that the disc is securely attached to seal. A plurality of through holes corresponding to the number of current collector nails is formed or otherwise defined in a second insulating disc. The through holes may be symmetrically arranged radially along the second disc 29 in FIG. 1 such that they align with the set of nails attached to the first disc. For example, for a cell having three anodes, each through hole may be formed at 120° apart radially along the second disc. In some embodiments, the second disc may be made of thin polyethylene. Other suitable non-conductive material may be utilized for the second disc. The second disc with the through holes may then be placed over the current collector nails such that the second disc is positioned adjacent and in contact with the first disc to provide electrical insulation between the first disc and the cathode.

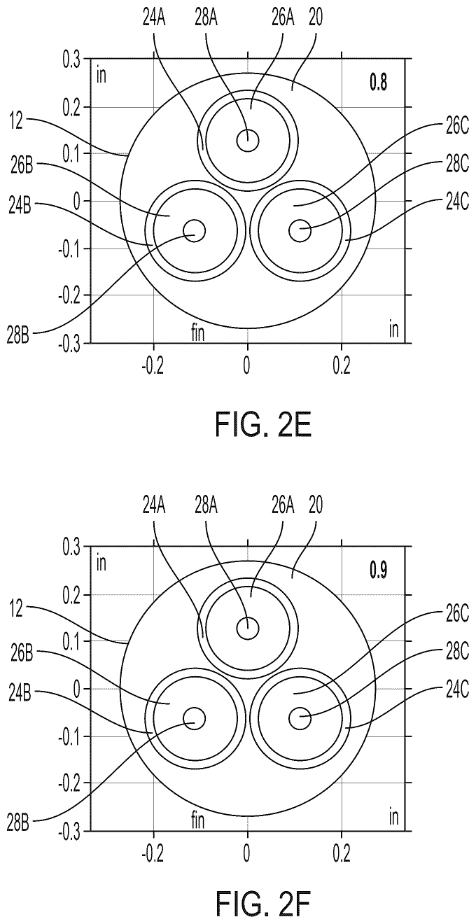

Referring to FIGS. 4a-4c, forming tools for forming the cathode and FIG. 4c, an example cathode pellets formation for an example electrochemical cell is shown. A cathode in the form of a cylindrical cathode pellet in accordance with various embodiments, may be formed via one or more manufacturing methods. The cathode pellet may be formed outside of the cell can 12 or may be formed in place with the cell can 12. As one example, the cathode pellet may be molded outside of the cell can. The cathode pellet may be formed as a single, continuous piece, by filling a mold with a cathode mixture (the cathode mixture as discussed above) and subjecting the cathode mixture within the mold to a high pressure to form the cathode pellets. In some embodiments, the mold may comprise a die having a cavity therein. In certain embodiments, anode compartment forming tools may be positioned within the mold prior to filling the mold with the cathode mixture, and the cathode mixture may then be added to the cathode mold around the anode compartment forming tools.

As shown in FIG. 4a, in some embodiments, the anode compartment forming tools may include core rods 42 extending from a base plate 44 or otherwise positioned vertically on the base plate 44. The number of core rods 42 may correspond to the desired number of anodes and may be spaced apart, for example symmetrically, based at least in part on the desired coefficient kᵣ. For example, the base plate 44 may include three core rods for manufacturing a triple anode electrochemical cell and the core rods may be spaced apart relative to each other based on the desired coefficient kᵣ. For example, the distance between the core rods may be greater for a desired coefficient kᵣ of 0.6 compared to a coefficient kᵣ of 0.2. The core rods 42 may have a cross-sectional shape corresponding to the desired shape of the anodes. For example, to form cylindrical anodes, the core rods 42 may be cylindrical. The core rods can be formed of metal, such as steel or other metals or alloys, or other materials. The diameter of the core rods may be selected based on the desired diameter of the anodes. For example, the diameter of the core rods may be substantially the same as the desired diameter of the anodes.

As shown in FIG. 4b, a die 46 may be placed onto to the base plate such that the core rods (e.g., at least a substantial portion of each core rod) are disposed within the die 46. The die 46 may have a cross-sectional shape corresponding to the desired shape of the cathode. For example, to form a cylindrical cathode, the die may be cylindrical. The die 46 may be embodied as a cylindrical die defining an opening therethrough and interior surface bounding the opening. The die 46 may be formed of a metal, such as steel or other metals or allows, or other materials. In some examples, the die may be plated on its interior with nickel, cobalt, and/or other metal alloys, or other material. The diameter of the die 46 may be selected based on the desired diameter of the cathode. For example, the diameter of the die may be substantially the same as the desired diameter of the cathode. As further shown in FIG. 4, the die 46 may be filled with the cathode mixture 20 after placing over the core rods 42, such that the cathode mixture 20 fills the region between the inner wall/interior surface of the die and the exterior surface of the core rods 42.

As shown in FIG. 4c, the cathode mixture 20 and the forming tools may then be subjected to pressure to form the cathode pellet. In one embodiment, a ram 47, such as an upper ram, may be leveraged to subject the cathode to pressure. For example, a ram 47 may be inserted into the die cavity/opening and then pressed against the cathode. The ram 47 may include a ram plate 47a and a ram rod 47b extending from the ram plate 47a. The cross-sectional shape of the ram plate 47a and/or the ram rod 47b may be cylindrical. However, it would be appreciated that the shape of the ram plate 47a and/or the ram rod 47b may be different in other examples. For example, the cross-sectional shape of the ram plate 47a and/or the ram rod 47b may depend on the desired shape of the cathode. The ram plate 47a may have a diameter that is larger than the diameter of the ram rod 47b. The ram plate 47a and the ram rod 47b may define a plurality of through holes 49. The number of through holes 49 may depend on the desired number of anodes. For example, to form a triple anode electrochemical cell, a ram 47 defining three through holes 49 may be utilized. Further, the cross-sectional shape of the through holes 49 may depend on the desired shape of the anodes or otherwise correspond to the shape of the core rods. For example, the ram plate 47a and the ram rod 47b may define through holes 49 having the same shape as the shape of the core rods.

The ram 47 may be positioned over the die cavity/opening such that the through holes 49 are aligned with the core rods, wherein the core rods 42 may be inserted within the through holes 49 when pressure is applied to the ram plate 47a. The through holes may have a diameter that is substantially the same as the diameter of the core rods 42. In one example, a hydraulic press such as a carver press may be utilized to press the ram 47 against the cathode to apply the desired force to the cathode. The die 46 with the ram 47 positioned above the die 46 may be positioned within the hydraulic press. An upper plate of the hydraulic press may then be caused to come in contact with the ram plate 47a via a lever of the hydraulic press. The desired pressure may then be applied by pulling down on the lever which may cause the upper plate of the hydraulic press to push the ram rod 47b down through the cavity of the die 46 and cause the cathode material to compress into a compact shape. After applying the desired pressure, the die 46 with the ram 47 may be removed from within the hydraulic press. The ram 47 may then be lifted off via the ram plate 47a leaving the die 46 and the core rods 42. Thereafter, the die 46 and the core rods 42 may be removed, forming a cathode pellet 20 having a plurality of cavities that define the anode compartments of the cell. The die 46 may be lifted of the base plate 44 to separate the die 46 from the core rods 42. The cathode pellet 20 may then be removed from the core rods to separate the cathode pellet from the die and core rods. For example, the cathode pellet 20 may be lifted off the base plate 44. FIG. 4d shows the cathode pellet 20 after separating the cathode pellet 20 from the die and core rods. As shown in FIG. 4d, the cathode pellet 20 may be substantially cylindrical and may include a plurality of cylindrical openings/anode compartments.

The resulting cathode pellet may be inserted into the electrochemical cell canister. In certain embodiments, a plurality of cathode pellets may be stacked (e.g., 3-4 pellets) within the interior of the canister. In those embodiments, an alignment tool (e.g., one or more pins) may be used to assist during insertion of the cathode pellets to ensure that the anode compartments are aligned between all of the cathode pellets. A separator, preferably a cup-shaped separator, is placed within each anode compartment such that the separator surrounds the inner wall of the respective anode compartment. Each separator may be positioned within the respective anode compartment such that the separator extends at least the length of, and around, the interior of the anode compartment. The cathode openings, now surrounded by the separator, is filled with anode material such that a separator is between the cathode and each anode.

The separator comprises an ionically conductive, electrically insulating material to separate the anode and cathode within the cell. The separator maintains a physical dielectric separation of the cathode's electrochemically active material from the electrochemically active material of the anode and allows for transport of ions between the electrode materials. In addition, the separator acts as a wicking medium for the electrolyte and/or as a collar that prevents fragmented portions of the negative electrode from contacting the top of the positive electrode. Separator can be a layered ion permeable, non-woven fibrous fabric. A typical separator usually includes two or more layers of paper. The separator may be formed either by pre-forming the separator material into a cup-shaped basket having a closed bottom portion that is subsequently inserted into a cavity defined by cathode pellet and the closed end of the can. Pre-formed separators are typically made up of a sheet of non-woven fabric rolled into a cylindrical shape that conforms to the inside walls of the anode and has a closed bottom end.

In certain embodiments, the separator may overlap one or both ends of the cathode, thereby providing insulating properties to one or both ends of the cathode to prevent undesirable short circuits between the cathode and the anode within the cell. It should be appreciated that the cathode pellet may be placed within the cell can prior to placement of the separator and/or the anode within the anode compartments of the cathode pellet.

The anode can be formed in a number of different ways as known in the art. For example, the anode components can be dry blended and added to the cell, with alkaline electrolyte being added separately or a pre-gelled anode process is utilized. In one embodiment, the zinc and solid zinc oxide powders, and other optional powders other than the gelling agent, are combined and mixed. Afterwards, the surfactant is introduced into the mixture containing the zinc and solid zinc oxide. A pre-gel comprising alkaline electrolyte solution, soluble zinc oxide and gelling agent, and optionally other liquid components, are introduced to the surfactant, zinc and solid zinc oxide mixture which are further mixed to obtain a substantially homogenous mixture before addition to the cell. Alternatively, in a further preferred embodiment, the solid zinc oxide is pre-dispersed in an anode pre-gel comprising the alkaline electrolyte, gelling agent, soluble zinc oxide and other desired liquids, and blended, such as for about 15 minutes. The solid zinc oxide and surfactant are then added, and the anode is blended for an additional period of time, such as about 20 minutes. The amount of gelled electrolyte utilized in the anode is generally from about 25 to about 35 weight percent, and for example, about 32 weight percent based on the total weight of the anode. Volume percent of the gelled electrolyte may be about 70% based on the total volume of the anode 26.

Each anode may be inserted into the cell in any suitable manner. If an anode is flowable when it is added to the cell, it may be disposed as a liquid to flow to fill the space defined or otherwise bounded by the separator. Thus, the anode may be added into the can after placement of the cathode and separator within the interior of the cell can.

In other embodiments, the anode may be dispensed into the cell under pressure, for example, by extrusion. If an anode is a solid, such as a packed mass of particulate anode material or a continuous 3-dimensional (3D) anode (e.g., comprising an active material of zinc and/or one or more additives), the anode may be formed into a desired shape prior to insertion of the same into the cell. In such embodiments, the anode may be added to the cell can after the outer cathode and separator have been placed in the cell.

Moreover, the anode may be formed into a desired shape outside of the cell (e.g., by ring molding the anode into one or more anode rings that may be added to fill the cell can with a desired anode quantity). In such embodiments, a plurality of anode rings (e.g., 3 or 4 anode rings) may be individually placed into a cathode opening to provide a desired quantity of anode therein. In some embodiments, a first anode ring is inserted into the can. An alignment pin may be inserted and leveraged to pushed down the anode ring onto the can by pressing down on the anode ring using, for example, a carver press. A second, third, and/or fourth anode rings may then be inserted into the can in the same manner. Once all rings are inserted, the plunger pusher and alignment pin may then be removed.

In other embodiments, the anode may be formed into a desired ring shape within the cell can. For example, impact molding may be utilized, by pouring particulate anode active material into the cell can, and inserting a ram into the center of the cell can 12 to impact mold the anode material into a ring pressed against an interior surface of the separator within the respective anode compartment.

In addition to the aqueous alkaline electrolyte absorbed by the gelling agent during the anode manufacturing process, an additional quantity of an aqueous solution of alkaline metal hydroxide, i.e., “free electrolyte,” may be added to the cell during the manufacturing process. The free electrolyte may be incorporated into the cell by disposing it into the cavity defined by the cathode or anode, or combinations thereof. The method used to incorporate free electrolyte into the cell 10 may not be critical provided it is in contact with the anode, cathode, and separator. In one embodiment, free electrolyte is added both prior to addition of the anode mixture as well as after addition. In one embodiment, about 0.97 grams of 34 weight percent KOH solution is added to an LR6 type cell as free electrolyte. This free electrolyte solution comprises dissolved zinc oxide in a range of about 0.01-6.0 weight percent. In embodiments, the free electrolyte solution comprises dissolved zinc oxide in an amount of greater than, less than, or equal to about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0 weight percent, or in any range between two of these values. In a preferred embodiment, the free electrolyte solution comprises dissolved zinc oxide in an amount of between about 4.0-6.0 weight percent. The free electrolyte solution may be about 85%, 86%, 87%, 88%, 89%, 90%, 91%, 92%, 93%, 94%, 95%, 96%, 97%, 98%, 99%, or 100% saturated with dissolved zinc oxide.

In an embodiment, the free electrolyte solution comprises potassium hydroxide (KOH), sodium hydroxide (NaOH), lithium hydroxide (LiOH), magnesium hydroxide (Mg(OH)₂), calcium hydroxide (Ca(OH)₂), magnesium perchlorate (Mg(ClO₄)₂), magnesium chloride (MgCl₂), or magnesium bromide (MgBr₂).

As an example, a shot of free electrolyte may be added to the cell after insertion of the anode and/or cathode into the cell. In one example, one or more shots of free electrolyte may be added to the cell after insertion of the anode, cathode, and separator into the cell interior.

Once the active materials are added to the cell, the cell may be sealed with a seal and one or more covers, and the cell can may be crimped to close the open end of the cell can 12 to form the complete cell. For example, the seal and cover assembly 40 with the current collector 28 is assembled to the can via the open end of the can, such that each prong (e.g., each nail) of the current collector is inserted within a corresponding anode. In certain embodiments, a plastic film label (e.g., a heat-shrink label) may be secured to the exterior of the cell and formed over the peripheral edges of the can, to provide insulation against incidental short-circuit connection between the positive and negative terminals of the battery cell.

The foregoing descriptions of assembly methods should be taken as mere examples. The sequence of inserting the electrodes, separator, electrolyte, cover and assembly, and current collector into the cell may be varied to best suit the compositions and shapes of those components.

### Optimized Discharge Performance Designs

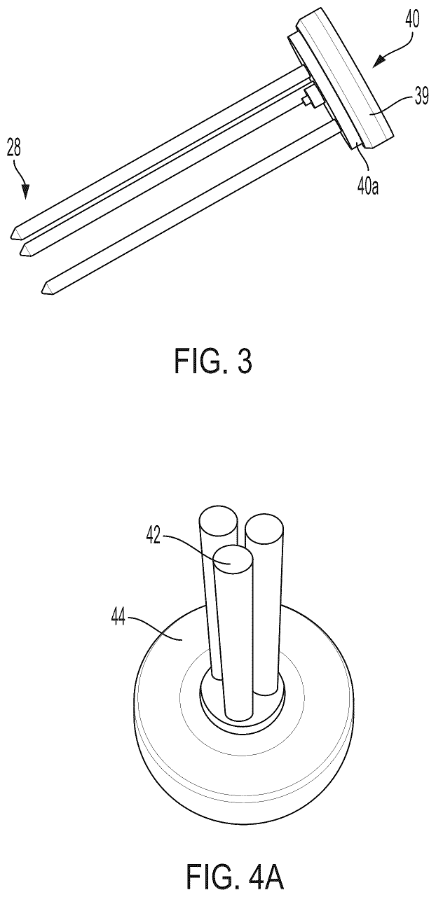

FIG. 5 illustrates discharge profiles (both experimental and simulated discharge profiles) for an electrochemical cell in accordance with some embodiments. FIG. 5 illustrates the results of experiment and simulation for discharge performance test that was performed with triple anode alkaline battery design (e.g., a cell having three anodes) according to some embodiments of the present disclosure and bobbin-style alkaline batteries with single anode for comparison. The discharge performance test was performed according to a standard ANSI Digital Still Camera (DSC) testing method. Discharge time is indicated on the x-axis in minutes and voltage is indicated on the y-axis in volts. During the test, the voltage was measured as a function of discharge time for a cell having three anodes and a cell having a single anode. Both cells were discharged with the same electrical power draw. As indicated in FIG. 5, the triple anode cell has a discharge time (measured until the cell voltage crosses a lower threshold voltage of 1.05V) of about 148 minutes, while a cell having a single anode has a discharge time of about 78 minutes. As indicated in FIG. 5, when a simulated test is completed based on the same cell configurations, the triple anode cell has a discharge time (measured until the cell voltage crosses a lower threshold voltage of 1.05V) of about 120 minutes, while a cell having a single anode has a discharge time of about 60 minutes.

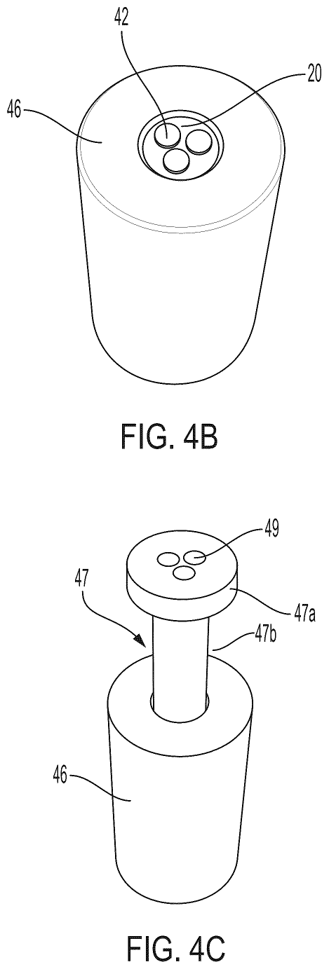

FIG. 6 illustrates the effect of separator thickness on DSC run time for an electrochemical cell in accordance with some embodiments. FIG. 6 graphically illustrates theoretical experiments for how a change in separator thickness impacts discharge performance time. DSC run time is indicated on the y-axis in minutes and separator thickness is indicated on the x-axis in mil. During the test, the DSC run time was measured as a function of separator thickness. As indicated in FIG. 6, DSC run time decreased with increasing separator thickness.

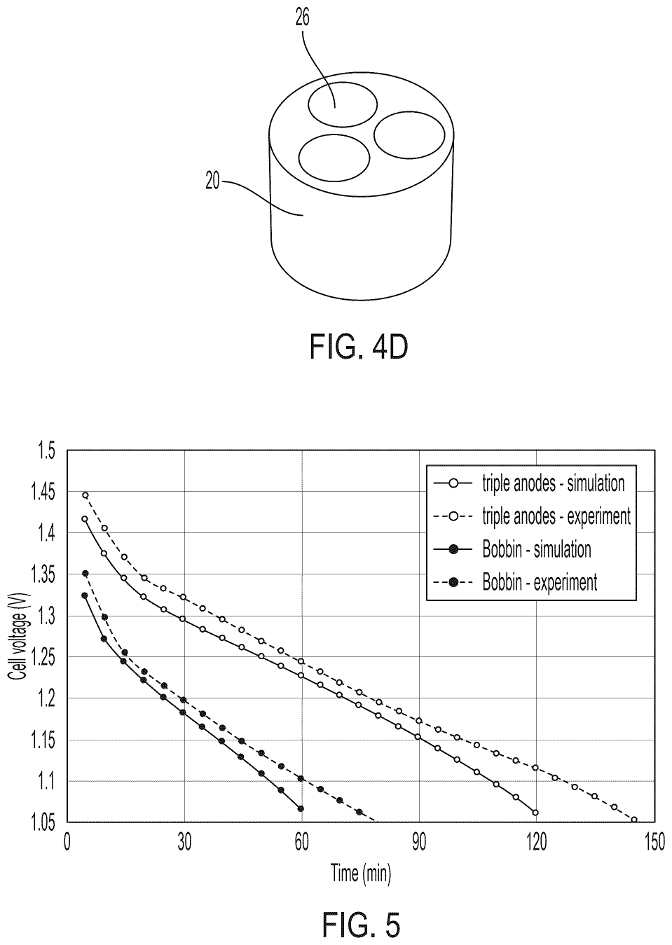

FIG. 7 illustrates the effect of anode-to-cathode ratio on DSC run time for an electrochemical cell in accordance with some embodiments. FIG. 7 graphically illustrates theoretical experiments for how a change in anode-to-cathode ratio impacts discharge performance time. DSC run time is indicated on the y-axis in minutes and anode-to cathode ratio is indicated on the x-axis. During the test, the DSC run time was measured as a function of anode-to-cathode ratio. As indicated in FIG. 7, DSC run time increased with increasing anode-to-cathode ratio.

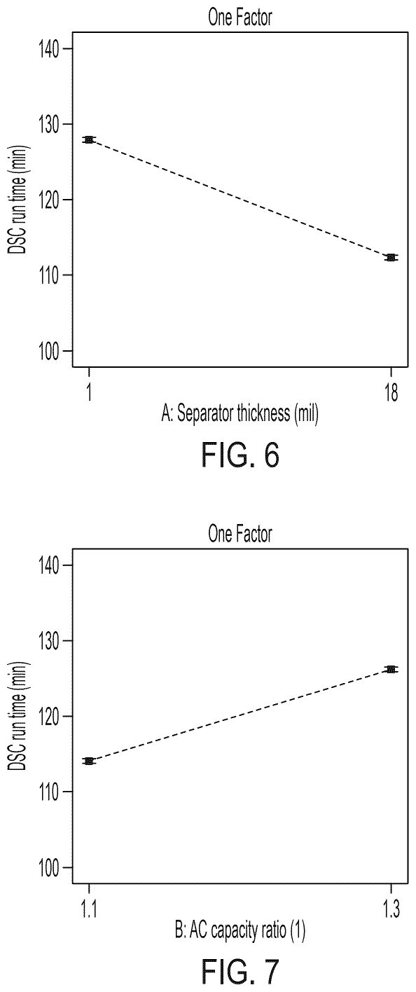

FIG. 8 illustrates the effect of coefficient kᵣ (as impacted by changing the parameter kᵣ during cell design) on DSC run time for an electrochemical cell in accordance with some embodiments. FIG. 8 graphically illustrates theoretical experiments for how a change in coefficient k impacts discharge performance time. DSC run time is indicated on the y-axis in minutes and coefficient kᵣ is indicated on the x-axis. During the test, the DSC run time was measured as a function of coefficient kᵣ. As indicated in FIG. 8, DSC run time varies with the coefficient kᵣ, while maintaining kᵣ in the middle range (e.g., between 0.4 and 0.8) ensures optimal DSC run time. Therefore, it is believed that discharge performance of a multi-anode cell design varies with coefficient kᵣ.

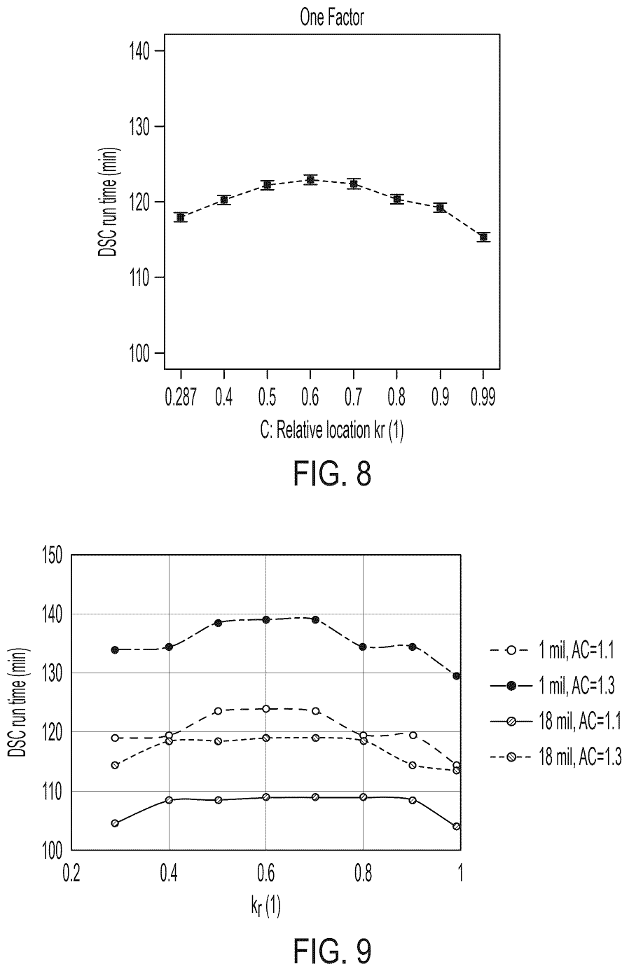

As indicted above, the inventors have found that anode-to-cathode ratio, separator thickness, and coefficient kᵣ are design parameters of a multi-anode cell that impact discharge performance and are interrelated. In this regard, different combinations of anode-to-cathode ratio, separator thickness, and coefficient kᵣ may provide different DCS run times. FIG. 9 illustrates the effect of changing the coefficient kᵣ, for different combinations of anode-to-cathode ratio and separator thickness. FIG. 9 graphically illustrates theoretical experiments for how a change in coefficient kᵣ impacts discharge performance of a multi-anode cell under different combinations of anode-to-cathode ratio and separator thickness. DSC run time is indicated on the y-axis in minutes and relative location is indicated on the x-axis. During the test, the DSC run time was measured as a function of coefficient kᵣ. As indicated in FIG. 9, DSC run time varied for the different combinations of anode-to-cathode ratio and separator thickness. Therefore, it is believed that the coefficient kᵣ, varies with the anode-to-cathode ratio and separator thickness parameters, which in turn impacts discharge performance.

Further, it is believed therefore that optimal combinations of anode-to-cathode ratio, separator thickness, and coefficient kᵣ may be selected in accordance with various embodiments of the present disclosure. For example, as indicated above, separator thickness may be selected from between 0.1 mil and 1 mil, between 1 mil and 5 mil, between 5 mil and 10 mil, and between 10 mil and 18 mil. In some embodiments, to achieve optimal discharge performance, the separator thickness is selected from between 10 mil and 18 mil, anode-to-cathode ratio is selected from between 1.1 and 1.3 mil, and the coefficient kᵣ is selected from between 0.5 and 0.7 or between 0.4 and 0.8. In some embodiments, to achieve optimal discharge performance, separator thickness is selected from between 0.1 mil and 1 mil, anode-to-cathode ratio is selected from between 1.1 and 1.3 mil, and the coefficient is selected from between 0.5 and 0.7 or between 0.4 and 0.8. In some embodiments, to achieve optimal discharge performance, the separator thickness is selected from between 1 mil and 18 mil, anode-to-cathode ratio is selected from between 1.1 and 1.3 mil, and the coefficient kᵣ is selected from between 0.5 and 0.7 or between 0.4 and 0.8.

Accordingly, an electrochemical cell 10 is provided in accordance with at least some embodiments of the present disclosure, which has at least optimal anode-to-cathode ratio, optimal separator thickness, and optimal coefficient kᵣ, which in turn results in optimal discharge performance as compared to conventional single anode cell.

Further, as shown in FIG. 9, in some embodiments, to achieve optimal DSC run time the preferred optimal combination may be anode-to-cathode ratio of about 1.3, separator thickness of about 18 mil, and kᵣ between 0.4 and 0.8; the more preferred optimal combination may be anode-to-cathode ratio of about 1.1, separator thickness of about 1 mil, and kᵣ between 0.5 and 0.7 or between 0.4 and 0.8, and the most preferred optimal combination may be anode-to-cathode ratio of about 1.3, separator thickness of about 1 mil, and kᵣ between 0.5 and 0.7 or between 0.4 and 0.8. In certain embodiments, where the anode-to-cathode ratio is about 1.1 and the separator thickness is about 18 mil, the optimal kᵣ value may be between 0.5 and 0.7 or between 0.4 and 0.9.

Note that the active material chemistry (i.e., the mixture of anode material within the anode, and the mixture of cathode material within the cathode) remained the same for all cell designs during the testing.

While embodiments have been illustrated and described in detail above, such illustration and description are to be considered illustrative or exemplary and not restrictive. It will be understood that changes and modifications may be made by those of ordinary skill within the scope and spirit of the following claims. Embodiments include any combination of features from different embodiments described above and below.

The embodiments are additionally described by way of the following illustrative non-limiting examples that provide a better understanding of the embodiments and of its many advantages. The following examples are included to demonstrate preferred embodiments. It should be appreciated by those of skill in the art that the techniques disclosed in the examples which follow represent techniques used in the embodiments to function well in the practice of the embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the embodiments.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

What is claimed is:

1. An electrochemical cell comprising:
a cell housing comprising cylindrical container having an interior radius xₜₒₜ and a closure;
a cathode positioned within the cylindrical container and defining a plurality of cylindrical openings therein;
a cylindrical anode disposed within each opening of the plurality of cylindrical openings to form a plurality of anodes, wherein each cylindrical anode has a radius r₂;
a current collector extending into each anode of the plurality of anodes and electrically connecting each anode of the plurality of anodes with a negative terminal of the cell housing; and
a separator disposed within each opening of the plurality of cylindrical openings and between each anode and the cathode wherein the separator has a thickness xₛ; wherein:
$${r}_{1 , max} = {x}_{tot} - {r}_{2} - {x}_{s}$$
$${r}_{1 , min} = \frac{( {r}_{2} + {x}_{s} )}{cos ( 30 ° )}$$
$${r}_{1} = {r}_{1 , min} + ( {r}_{1 , max} - {r}_{1 , min} ) {k}_{r}$$
r₁ is a distance between a center of the cylindrical container and a center of each cylindrical anode, and
kᵣ is a coefficient between 0.4-0.8.

2. The electrochemical cell of claim 1, wherein the plurality of anodes consists of three anodes.

3. The electrochemical cell of claim 1, wherein the thickness of the separator is between 0.1 mil and 1 mil.

4. The electrochemical cell of claim 1, wherein the thickness of the separator is between 1 mil and 5 mil.

5. The electrochemical cell of claim 1, wherein the thickness of the separator is between 5 mil and 10 mil.

6. The electrochemical cell of claim 1, wherein the thickness of the separator is between 10 mil and 18 mil.

7. The electrochemical cell of claim 1, wherein the thickness of the separator is between 10 mil and 18 mil, and a ratio between a quantity of anode active material within the plurality of anodes to a quantity of cathode active material within the cathode is between 1.1 and 1.3.

8. The electrochemical cell of claim 1, wherein the anode material comprises Zinc and the cathode active material comprises manganese dioxide.

9. The electrochemical cell of claim 1, wherein the thickness of the separator is between 0.1 mil and 1 mil, kᵣ is between 0.5 and 0.7, and a ratio between a quantity of anode active material within the plurality of anodes to a quantity of cathode active material within the cathode is between 1.1 and 1.3.

10. The electrochemical cell of claim 1, wherein the thickness of the separator is between 1 mil and 18 mil, kᵣ is between 0.5 and 0.7, and a ratio between a quantity of anode active material within the plurality of anodes to a quantity of cathode active material within the cathode is between 1.1 and 1.3.

11. The electrochemical cell of claim 1, wherein centers of the plurality of anodes are spaced equally around a circle having a radius r₁ within the cylindrical container.

12. The electrochemical cell of claim 1, wherein the current collector comprises a plurality of conductive prongs electrically connected to an outer cover.

13. The electrochemical cell of claim 1, wherein the kᵣ is about 0.6.

14. The electrochemical cell of claim 1, wherein the kᵣ is between 0.5 and 0.7.

15. A method of manufacturing an electrochemical cell, the method comprising:
placing a cathode within a cell housing comprising a cylindrical container having an interior radius xₜₒₜ and a closure, wherein the cathode is in contact with an interior surface of the cylindrical container and defines a plurality of cylindrical openings, each cylindrical opening having an inner surface;
covering the inner surface of each cylindrical opening of the plurality of cylindrical openings with a separator; wherein the separator has a thickness xₛ;
disposing cylindrical anode within each cylindrical opening to form a plurality of anodes, wherein each cylindrical anode has a radius r₂, wherein each cylindrical anode of the plurality of anodes is separated from the cathode by the separator;
extending a current collector into each anode of the plurality of anodes, wherein the current collector is electrically connected to a negative terminal cover; and
sealing the cylindrical container with the negative terminal cover; wherein:
$${r}_{1 , max} = {x}_{tot} - {r}_{2} - {x}_{s}$$
$${r}_{1 , min} = \frac{( {r}_{2} + {x}_{s} )}{cos ( 30 ° )}$$
$${r}_{1} = {r}_{1 , min} + ( {r}_{1 , max} - {r}_{1 , min} ) {k}_{r}$$
r₁ is a distance between a center of the cylindrical container and a center of each cylindrical anode, and
kᵣ is a coefficient between 0.4 and 0.8.

16. The electrochemical cell of claim 15, wherein the plurality of anodes consists of three anodes.

17. The electrochemical cell of claim 15, wherein the kᵣ is about 0.6.

18. The electrochemical cell of claim 15, wherein the kᵣ is between 0.5 and 0.7.

19. The electrochemical cell of claim 15, wherein the current collector comprises a plurality of conductive prongs electrically connected to an outer cover.

20. A tool set for forming a cathode pellet, the tool set comprising:
a cylindrical base plate;
a plurality of core rods configured for being positioned vertically on the cylindrical base plate;
a cylindrical die defining an opening therethrough, wherein the cylindrical die is configured for being positioned over the plurality of core rods, wherein the cylindrical die has a diameter that is substantially the same as a diameter of the cylindrical base plate; and
a ram configured for being positioned over the cylindrical die, wherein:
the ram comprises a ram plate and a ram rod extending from the ram plate,
the ram plate has a diameter that is greater than a diameter of ram rod,
the ram rod defines a plurality of through holes having a diameter that is substantially the same as a diameter of each core rod of the plurality of core rods, and the plurality of core rods is configured for being inserted within the plurality of through holes when pressure is applied to the ram.
